(19) United States
(12) Patent Application Publication
(10) Pub. No.: US 2018/0173262 A1
(43) Pub. Date: Jun. 21, 2018

(54) THREE-DIMENSIONAL POWER STAGE AND ADAPTIVE PIPELINE CONTROL

(71) Applicant: The Hong Kong University of Science and Technology, Hong Kong (CN)

(72) Inventors: Fan YANG, Hong Kong (CN); Kwok Tai Philip MOK, Hong Kong (CN)

(21) Appl. No.: 15/736,894

(22) PCT Filed: Jun. 13, 2016
(86) PCT No.: PCT/CN2016/085522

§ 371 Date: Dec. 15, 2017

Related U.S. Application Data
(60) Provisional application No. 62/230,803, filed on Jun. 16, 2015.

(51) Int. Cl. G05F 1/575; G05F 1/563

(52) U.S. Cl. CPC G05F 1/575; G05F 1/563

(57) ABSTRACT

A digital linear voltage regulator includes a power stage (208), arranged in a hierarchical grouping of power stage units. The power stage (208) is configured to deliver power to a load (212). The digital linear voltage regulator further includes a mixed-signal controller (206), configured to control each power stage unit in the power stage (208) by conditionally adjust a number of active power stage units in the power stage (208) based on a comparison of a feedback voltage of the load (212) and a reference voltage; wherein the hierarchical grouping of power stage units comprises N levels; wherein the power stage (208) comprises a number of M_{N} Nth level units, and an Nth level unit comprising a number of M_{N-1} (N−1)th level units; and wherein N is an integer greater than or equal to 3, and M_{N} and M_{N-1} are integers greater than or equal to 1.

### CROSS-REFERENCE TO RELATED APPLICATIONS

This patent application claims the benefit of U.S. Provisional Patent Application No. 62/230,803, filed Jun. 16, 2015, which is incorporated herein by reference.

### FIELD

The disclosure relates to power stage structure design and control methods for digital linear voltage regulators, and in particular to such regulators which are used to supply digital integrated circuits that have ultra-fast switching activities, for instance, to low drop-out regulators incorporating these structures and techniques.

### BACKGROUND

The ever-growing ultra-thin and ultra-light weight portable mobile devices market has driven the great demand for system-on-a-chip (SoC) designs that come along with tens to hundreds of systems or sub-systems being integrated onto a single chip. The scaling of physical dimensions of most recent portable mobile devices has put a bottleneck on the power supply capability provided by the battery. To prolong the lifetime of these portable devices which contain high-performance SoC with high power consumption, the supply voltage of most of the digital integrated circuits (IC) has to scale down to sub-threshold or near-threshold region, especially during standby or idling mode. However, conventional power management techniques implemented mostly in analog circuits cannot provide the required performance, given that analog circuits with scaling supply voltage have to consume more power to maintain performance, such as high gain and high bandwidth.

It has since been a challenge in power management IC (PMIC) design to achieve generation of a fine regulated supply voltage with ultra-fast transient responses that can deliver current ranging from hundreds of milli-amperes to several amperes for digital circuits in the SoC. Digital linear voltage regulators, or sometimes referred to as digital low dropout regulators, is a new category of PMIC that has the potential to fit in these stringent power management requirements of SoC. Digital linear voltage regulators distinguish themselves from their analog counterparts mainly by using a digital controller loop to fully turn-on or turn-off for a portion of or whole units of pass transistors that act as power stages. Conventional digital linear regulator designs can provide functional but non-optimized performance, but these designs suffer from slow transient response or high quiescent current consumption, which are not preferred in PMIC design for a large system such as an SoC.

### SUMMARY

An embodiment of the disclosure provides a digital linear voltage regulator including a power stage, arranged in a hierarchical grouping of power stage units. The power stage is configured to deliver power to a load. The digital linear voltage regulator further includes a mixed-signal controller, configured to control each power stage unit in the power stage by conditionally adjust a number of active power stage units in the power stage based on a comparison of a feedback voltage of the load and a reference voltage; wherein the hierarchical grouping of power stage units comprises N levels; wherein the power stage comprises a number M_{N} of Nth level units, and an Nth level unit comprising a number M_{N-1} of (N−1)th level units; and wherein N is an integer greater than or equal to 3, and M_{N} and M_{N-1} are integers greater than or equal to 1.

Another embodiment of the disclosure provides an adaptive pipeline controller for a digital linear voltage regulator. The adaptive pipeline controller includes a plurality of ALUs with bi-directional data flow, configured to compare an input signal with a reference signal. The plurality of ALUs include M_{B} total ALUs with three configurations: (1) the plurality of ALUs are reconfigured into a subset of M_{R} ALUs in a first configuration with M_{R}≤M_{B}; (2) a subset of M_{C} ALUs in a second configuration with M_{C}≤M_{B}; and (3) all M_{B} ALUs in a third configuration. M_{R} is a total number of rows, M_{C} is a total number of columns, and M_{B} is a total number of bits. A row is made up of one or more columns, and a column is made up of one or more bits. The adaptive pipeline controller further includes M_{R}+M_{C} global latches, configured to store ALU results in the first configuration and the second configuration. The adaptive pipeline controller also includes M_{B} local latches, configured to store ALU results in the third configuration. A controller is included in the adaptive pipeline controller to combine the values of the M_{R}+M_{C} global latches with the M_{B} local latches to drive a power stage in the digital linear voltage regulator.

Yet another embodiment of the disclosure provides a digital linear voltage regulator, with a power stage and a mixed-signal controller. The power stage is arranged in a hierarchical grouping of power stage units and is configured to deliver power to a load. The mixed-signal controller is configured to conditionally adjust a number of active power stage units in the power stage based on a comparison of a feedback voltage of the load and a reference voltage; wherein the hierarchical grouping of power stage units comprises N levels; wherein the power stage comprises a number M_{N} of Nth level units, and an Nth level unit comprising a number M_{N-1} of (N−1)th level units; and wherein N is an integer greater than or equal to 3, and M_{N} and M_{N-1} are integers greater than or equal to 1.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 is an exemplary schematic circuit diagram of a generic linear voltage regulator;

FIG. 2 is a schematic circuit diagram illustrating the structure of a digital linear voltage regulator in an exemplary embodiment;

FIG. 3 illustrates a detailed view of a power stage in an exemplary embodiment, with the row/column address and data controller connecting to the address/data bus and bit data controller embedded with the power stage unit;

FIG. 4A shows a more detailed view of the row/column address and data controller of FIG. 3, with an equivalent row/column data memory map;

FIG. 4B shows a more detailed view of the bit data controller of FIG. 3, illustrating a multiplexer connecting to a driver which directly controls a single power stage unit;

FIG. 5A illustrates a pipeline controller in a first operation mode, with bi-directionally connected arithmetic logic units and selected storage units;

FIG. 5B illustrates the pipeline controller in an idle or standby mode, with the arithmetic logic unit connections being cut off and unselected storage units;

FIG. 6 shows the operation of adaptive pipeline controller in an exemplary embodiment, including three states in particular, and connections to analog signal inputs and digital storage units;

FIG. 7A is the diagram illustrating the working of a finite state machined that governs an adaptive digital pipeline controller by generating proper states;

FIG. 7B is a group of waveforms illustrating how the control flag signal SteQ in the finite state machine of FIG. 7A is generated in different scenarios;

FIG. 8A shows a comparison of performance in load transient response, in particular, between an exemplary linear voltage regulator according to an exemplary embodiment of the invention versus conventional linear voltage regulators (the comparison illustrates the output voltage waveforms as well as the output current transient waveform);

FIG. 8B shows a comparison of performance in reference, in particular, between an exemplary linear voltage regulator according to an exemplary embodiment of the invention, versus conventional linear voltage regulators (the comparison illustrates the output voltage waveforms as well as the reference voltage transient waveform).

### DETAILED DESCRIPTION

As a result of the shortcomings of conventional digital linear voltage regulators, there is a need in innovations of the design of digital linear voltage regulators tailored for ultra-fast switching digital circuits, in particular in design of the power stage and its controller that target at enhanced speed and resolution performance.

Exemplary embodiments of the invention provide methods, apparatuses, and systems relating to voltage regulation using row-column-bit three-dimensional (3D) power stage with adaptive digital pipeline control. Digital linear voltage regulators utilizing these exemplary embodiments are able to achieve significantly enhanced performance, particularly with respect to speed and resolution, relative to conventional digital linear voltage regulators. The 3D power stage divides and controls power stage units for a speed-resolution balance. Furthermore, a digital adaptive pipeline controller provides for controlling the power stage units via reconfiguring the number of pipeline stages adaptive to in-situ transient speed or resolution requirements. Other exemplary embodiments of the invention may further be applied not just to digital linear regulators, but may also be extended to any devices utilizing switching-mode power supplies to provide a fine-grained power supply with ultra-fast voltage regulation.

Exemplary embodiments of the invention are able to deliver a regulated voltage with fine resolution for supplying fast-switching digital circuits. The pass transistor, or power transistor, of a linear voltage regulator is linearly divided into a large number of small units. Further, in an exemplary embodiment, an adaptive pipeline control is provided to drive the 3D power stage. During operation, turning each bit on or off will only introduce a small error, or ripple, at the regulated voltage, and turning a whole row or column of bits on or off will accelerate the transient response, thus assuring a fine resolution as well as speed. The linear voltage regulator, including the 3D power stage and adaptive pipeline control according to embodiments of the invention, is thus able to deliver output voltage with much finer resolution and recovers faster from ultra-fast transient at loading current and/or reference voltage, compared with conventional digital linear voltage regulators. Accordingly, exemplary embodiments of the invention are applicable in supplying digital integrated circuits with an ultra-fast switching load and/or ultra-fast switching voltage reference, and fits well in the scaling trend of more advanced semi-conductor technologies.

In an exemplary embodiment, the 3D power stage includes three main parts. First, a large number of linearly divided pass transistor units can be configured to be turned on or off individually or together with other units as a group (e.g., forming a column, or a row including multiple columns). Second, a row/column address and data controller, which configure the turn-on and turn-off of the power stage in coarse resolution. And third, a bit controller and driver implemented in close proximity to every power stage unit to help achieve a fine resolution.

In an exemplary embodiment, the adaptive pipeline control used for controlling the 3D power stage also includes three main parts. First, a certain number of arithmetic logic units (ALUs) and the interface circuits between two adjacent ALUs. Second, a group of storage units that are connected to the ALUs. And third, a finite state machine (FSM) that governs reconfiguring the combinations of ALUs and corresponding storage units such that in a closed feedback loop the large number of the 3D power stage units are controlled accordingly.

In an exemplary embodiment, the 3D power stage with the adaptive pipeline control is used in constructing a feedback loop for a digital linear voltage regulator and thus supplying regulated voltage for ultra-fast switching digital circuits.

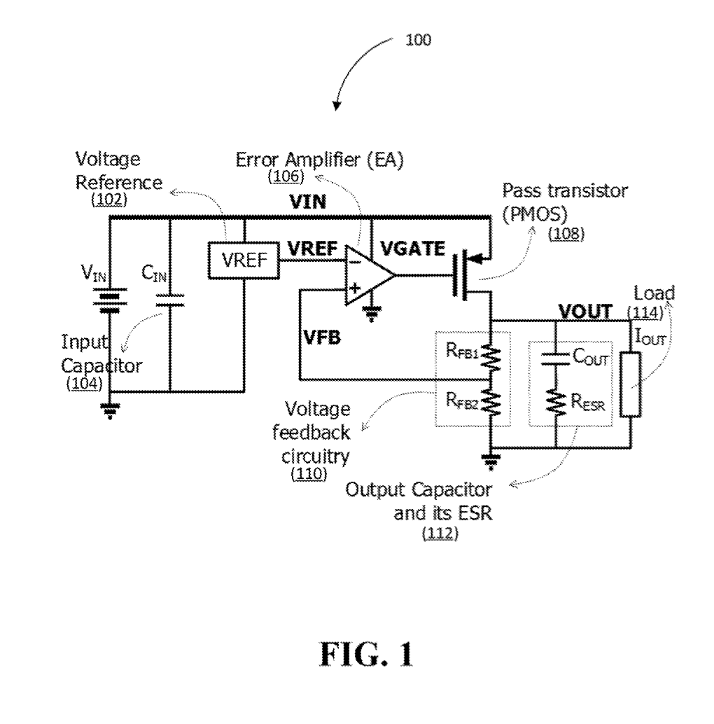

FIG. 1 illustrates a block diagram for a generic linear voltage regulator 100 having a voltage reference 102, input capacitor 104, error amplifier (EA) 106, P-type power stage or pass transistor 108, voltage feedback circuitry 110, output capacitor and ESR 112, and load 114. The voltage regulator may be connected between a DC supply voltage V_{IN} at node VIN and ground. The voltage regulator receives the DC reference voltage V_{REF} at node VREF generated from voltage reference circuit 102. The function of the voltage regulator is to supply load 114 with a regulated voltage V_{OUT} at node VOUT. The controller of the generic linear voltage regulator 100, which includes EA 106, is configured to generate a correct gate signal V_{GATE} at node GATE, so that in the closed loop V_{FB}, a linear portion of output voltage V_{OUT} is set close to reference voltage V_{REF}, which enables a large output current I_{OUT} to be delivered to the load 114.

The voltage regulator may utilize a pass transistor 108 of different sizes, and different controllers, largely depending on the requirements of the load 114. Examples of three different types of loads are a constant current load, a resistive load, and a switching load. In some applications, the voltage regulator is used to directly supply these loads as the final stage. In some cases, when the load is a constant current load or a resistive load, the voltage regulator should correct the error at output node VOUT in FIG. 1 when either reference voltage V_{REF} or output current I_{OUT} changes. Thus, a fully analog controller may be used in order to detect the small error between V_{FB} and V_{REF} in FIG. 1.

The fine-grained feature of a voltage regulator using analog controller is unnecessary when supplying switching loads, such as digital circuits. In these instances, a digital controller may suffice to regulate the output voltage V_{OUT}. In digital circuits, the correctness of operation will not be jeopardized, as long as the supply voltage provided by voltage regulator is neither much lowered, nor boosted. The safe margin of supply voltage V_{IN}, thus determines the worst output voltage precision for the voltage regulator.

Another reason that the digital controller is chosen over its analog counterpart in supplying digital circuits is, when input voltage V_{IN}, in FIG. 1, decreases due to scaling in advanced technology, it becomes difficult for analog controllers to achieve a high gain or a fine precision compared to a large V_{IN} in the less advanced technology.

Additionally, in practice, digital circuits, as the load of voltage regulators, may be much more complicated, resulting in unpredictable switching of output current I_{OUT}. In order to supply a regulated voltage for switching loads such as digital circuits, the voltage regulator using a digital controller should be capable of switching ON/OFF a large number of piecewise pass transistors to cater to a wide range of possible output current I_{OUT} changes.

The application of digital linear voltage regulators, especially to near-threshold logic circuits, has become popular. Conventional digital linear voltage regulators are usually comprised of a linearly or non-linearly divided pass transistor and its controller, which can be identified in two categories. The first controller category usually contains a comparator that is driven by, for example, a shift-register, which needs a global clock, or a bidirectional pipeline, which may be clocked locally to save power. For such digital controllers, the comparator is usually required to achieve very fast speed in each comparison. The design limitations to the comparator may result in sacrificing the resolution due to the high dependence on number of bits in digitally representing the analog signal. The second controller category for digital linear voltage regulator uses phase locked loops (PLLs), or other semi-analog semi-digital techniques to generate a fine-grained output voltage. However, the speed may not be comparable to the controllers using single-stage comparators for analog to digital (A/D) conversion.

Relative to these conventional technologies, embodiments of the invention provide innovations both in the power stage design and the controller, so as to achieve better achieve a speed-resolution balance.

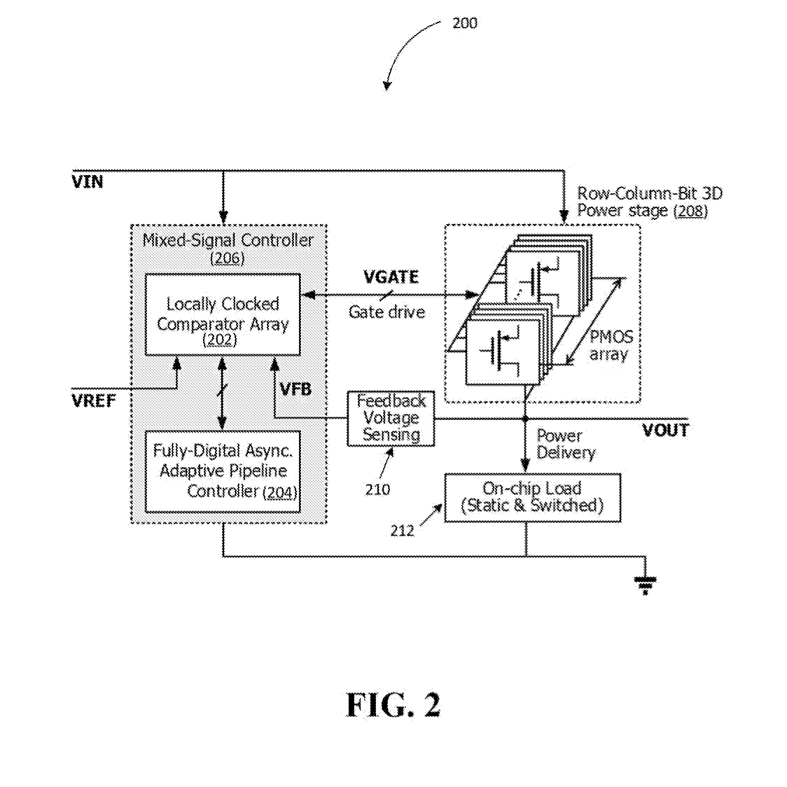

FIG. 2 illustrates a schematic circuit diagram of a digital linear voltage regulator 200 in an exemplary embodiment of the invention. It shows how piecewise pass transistors, referred to as power stage units 208 hereafter, are driven by mixed-signal controller 206. The mixed-signal controller 206 includes a locally clocked comparator array 202 and a fully-digital asynchronous adaptive pipeline controller 204. Similar to a voltage regulator with an analog controller, the generated output voltage, at node VOUT, is regulated within the precision requirement of load 212, which may be a digital circuit. In contrast to a voltage regulator with an analog controller, the voltage regulator explicitly defines the resolution, N-bit, of output voltage V_{OUT}, from the number M of power stage units (e.g. 2^{N}=M for M linearly divided power stage units).

However, as the increment of M and N generates a better resolution, the voltage regulator may consume much more power to achieve an equally fast response to any changes at the loading current and reference voltage, assuming the same control methodology is adapted in switching ON/OFF more power stage units as M and N increase. This extra power consumption may degrade the efficiency of the said voltage regulator 200, thus preventing the generation of a high resolution while maintaining high speed.

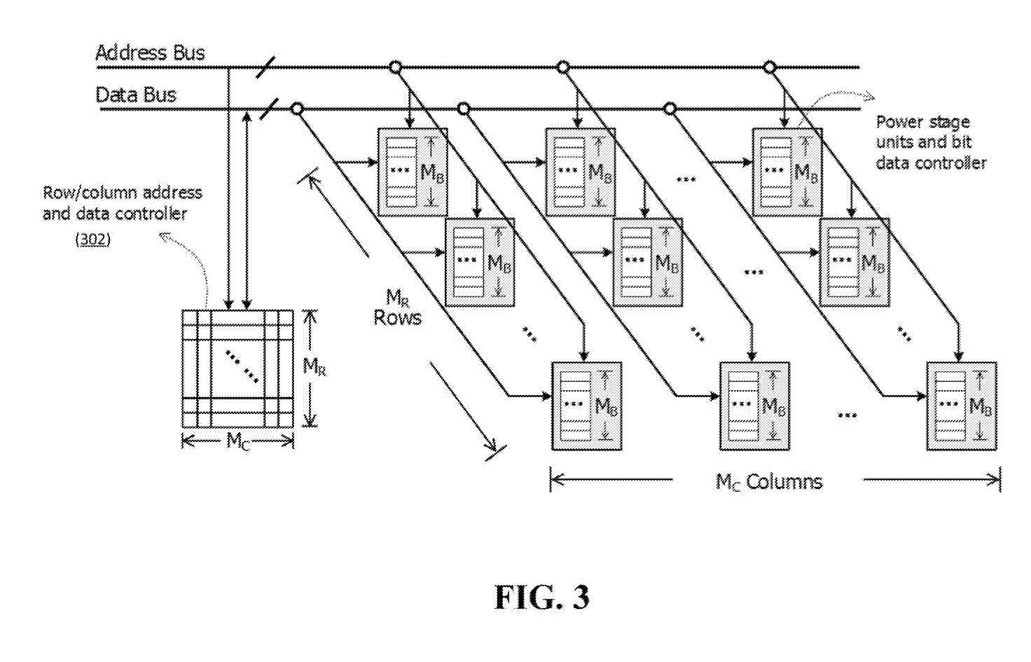

FIG. 3 illustrates a detailed view of the power stage 208, with row/column address and data controller connecting to the address/data bus and bit data controller embedded with the power stage unit 208, according to some embodiments of the disclosure. By using a row-column-bit three-dimensional (3D) power stage 208 and an adaptive pipeline controller 204, exemplary embodiments achieve multiple resolutions to fulfill speed-resolution balance requirements, in steady operation or during transient response. In an exemplary embodiment, the 3D power stage 208 is linearly divided into M_{R} rows, and each row is linearly divided into M_{C} columns, where each column is further linearly divided into M_{B} bits, as illustrated in FIG. 3.

For regulating the output voltage, the correct number of power stage units, in particular the correct number of M_{R} rows, M_{C} columns, and M_{B} bits shall be turned on/off. For the 3D power stage embodiment as illustrated in FIG. 3, a power-efficient method to control such a large number of units is provided. The mixed-signal controller 206 in FIG. 2 makes a decision, and the decision is stored on the address bus and data bus as illustrated in FIG. 3. The row/column address and data controller 302 represents a circuit block that provides data for each column of power stage units via the data bus, according to the signal from the address bus. The power stage units in FIG. 3, in group of columns, also receive the signal from address bus, and decide whether to use the row/column data or the bit data. During bit operation, only one column is being controlled, while the other columns maintain their previously latched data from the row/column address and data controller 302, via the data bus. Therefore, in some embodiments of the invention, the 3D power stage is able to access and update the data in its minimum unit, i.e., the bit unit, via the address bus and data bus. The maintenance of the address and data buses is performed by other circuit blocks, discussed in the following descriptions.

The terms “row”, “column” or “bit” are used mainly for a clearer demonstration of the topology relationship while not referring to the physical placement. More generally, a hierarchical grouping of N levels is described, where the power stage is made up of a number M_{N} of Nth level units, and an Nth level unit is made up of a number M_{N-1} of (N−1)th level units. N here is an integer greater than or equal to 3, and M_{N} and M_{N-1} are integers greater than or equal to 1 It will be appreciated that the “linear” division of “row”, “column” or “bit” (i.e., where N=3 with bit being the lowest level, column being an intermediate level, and row being a highest level) is not required, and other exemplary embodiments may use other, more complicated manners of division.

For example, the linear division of power stage units may be suitable for a wide range of applications in which the output voltage of the power stage needs to be regulated at a wide output current range as stable as possible. Such applications usually require such a design that a linearly-sized output current change can be realized by turning on a linearly-sized power stage unit. Some other exemplary applications may focus on the regulated output voltage tracking a wide range of reference voltage at a certain output current. Therefore, in such other applications, the power stage unit size may not be linear, and may instead be determined with respect to the specified output voltage and current levels.

The 3D power stage illustrated in FIG. 3 is a detailed view of the power stage 208 as shown in FIG. 2. In FIG. 3, the address bus and data bus provide a convenient and fast access to all M_{R} rows, M_{C} columns and M_{B} bits, meanwhile generating a fine resolution N-bit which can be expressed by: 2^{N}=M_{R}×M_{C}×M_{B}=M_{Total}. In addition to achieving the same high resolution compared with a conventional power stage that is directly divided into a large number M_{Total} of units and controlling each of them in a gradual access, the said 3D power stage allows a number of access combinations of rows, columns or bits. This extra freedom of accessing different numbers of bits at a time, referred to as 3D access of power stage units herein, provides for improvement of voltage regulation speed without loss of resolution. For example, in a conventional approach, if M_{Total}=1000 and all power stage units are currently OFF, in order to turn them all ON which is the worst-case scenario, it would take 1000 steps to turn on each power stage unit individually. A decision is made to turn ON power stage unit 1, then power stage unit 2, then power stage unit 3, and all the way till power stage unit 1000. When using an embodiment of the invention and selecting M_{R}=10, M_{C}=10, and M_{B}=10 in the same scenario, to turn ON all 1000 power stage units, only 10 steps would be needed to turn ON rows 1 to 10.

While in a worst-case scenario, which needs 999 (1000−1) units to be turned ON, 10 steps would be needed to search through rows 1 to 10 to turn ON 9 rows, 10 steps would be needed to search through columns 1 to 10 to turn ON 9 columns, and 10 steps will be needed to search through bits 1 to 10 to turn on 9 bits. Thus, only 30 steps, instead of 999 steps in a conventional approach, are needed to turn on the correct number of power stage units in this worst-case scenario. In this example, it is assumed that the number of decision steps to turn on n units at a certain dimension is only n+1, in which the extra one step is needed to correct the last unit before switching dimensions, e.g., from row-wise to column-wise control in the aforementioned embodiment of the invention.

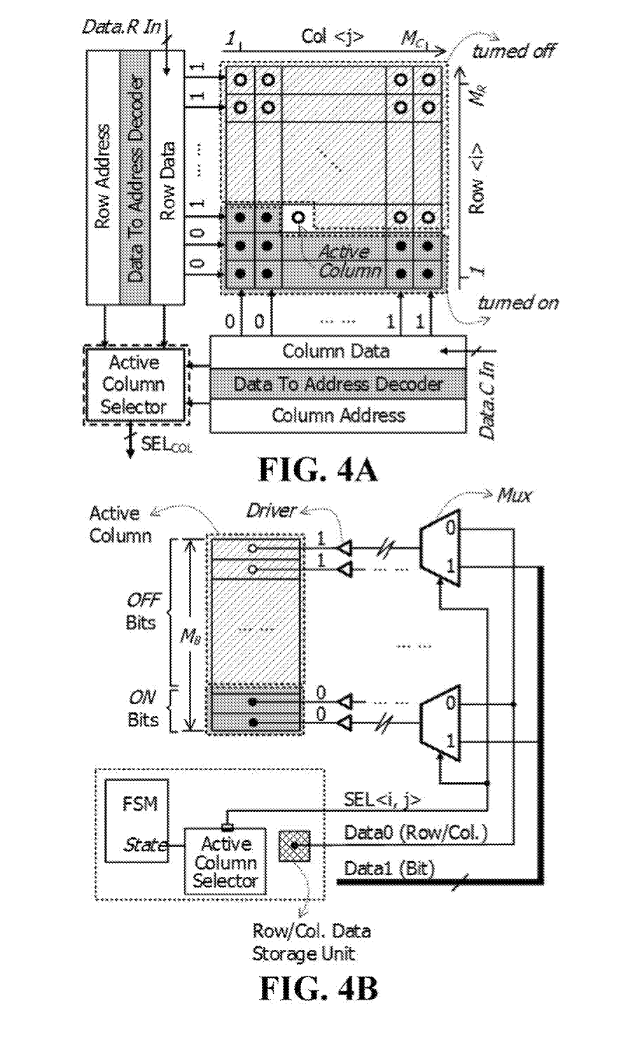

FIG. 4A illustrates a functional block in an exemplary embodiment which enables 3D access of power stage units. It is a more detailed view of subset row/column address and data controller 302 in FIG. 33. This block includes two parts: the first part is a row/column data and address decoder which determines the access of each bit either directly or by combination in group of row or column. The second part is an equivalent number M_{R}×M_{C} array of latches that store the digital code “0” or “1” which maps the turn ON or turn OFF of each power stage unit's bits in group of column. These digital codes can be passed, via data bus in FIG. 33, to addressed columns of power stage units, achieving a coarse resolution of regulation at the beginning of voltage regulation. FIG. 4A contains both row and column control operations of the mixed-signal controller 206; and in some embodiments, the row control is performed before the column control. For example, to obtain the state in FIG. 4A, row control turns ON the entire bottom two rows (Row<1> and Row<2>), and since the entire third row (Row<3>) does not need to be turned ON, column control is performed. During column control, the first column of the third row (Row<3>, Col<1>) is switched ON, then the second column of the third row (Row<3>, Col<2>) is turned ON, and then the controller determines that the entire third column of the third row (Row<3>, Col<3>) does not need to be turned ON so it designates this column as an active column. The previous discussion shows that when referring to a “group of row”, each horizontal row is controlled as a group, during row operation. When referring to a “group of column”, each vertical column in one row is controlled as a group, during column operation. As presented, row control operations allow control of a large number of units at a time, column control operations allow for control of a smaller number of units at a time.

Following FIG. 4A, another functional block, that realizes a fine resolution within the coarsely bounded vicinity of the target regulated voltage, is illustrated in FIG. 4B. Referring to FIG. 4A, the row/column address decoder may select one column at the border of the turned-ON and turned-OFF column-grouped power stage units. Here the term “border” does not refer to physical location of these power stages. The bits inside the selected column in FIG. 4A, referred to as active column hereafter, will not be controlled by the said digital code “0” or “1” that is passed on the global data bus Data0, but can be controlled bit-wise via the local data bus Data1 within the block in FIG. 4B. SEL<i,j> is a binary value (in this case a single bit) that determines whether to use the already stored value on the global data bus Data0 or a locally determined value on the local data bus Data1.

The said bit-wise control as illustrated in FIG. 4B, is similar to the aforementioned row- or column-wise control, in terms of the process of determining the number of units to be turned ON or OFF. Once row control and column control operations are performed, an active column is selected for the bit-wise control. One major difference among the bit-, column- and row-wise control, is the number of minimum sized units to be controlled per step change. In particular, the bit-wise control is usually gradual as each step change is relatively small; while the column- or row-wise control is more abrupt.

The functional blocks illustrated in FIG. 4A and FIG. 4B, when used to implement an embodiment of the 3D power stage, may provide a fast speed in access and switching ON/OFF of power stage units. These functional blocks may also result in providing a finer resolution compared with the conventional techniques that do not contain the bit-wise control such as shown in FIG. 4B.

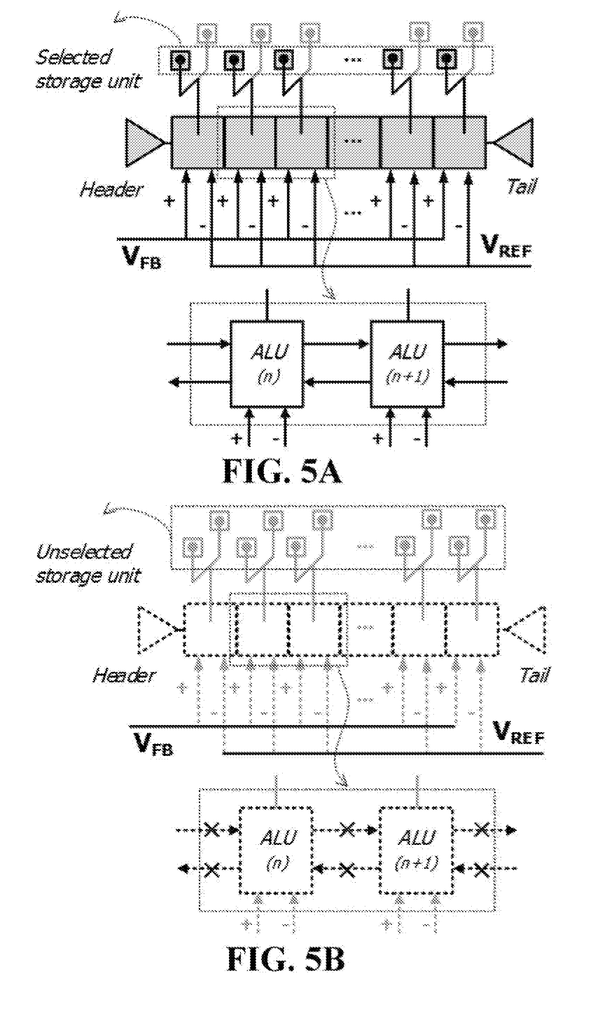

Another aspect of exemplary embodiments of the invention includes adaptive digital pipeline controller 204. The term “adaptive” mainly refers to the ability of being reconfigured into different numbers of cascaded pipeline units to provide digital control of the 3D power stage according to various requirements. The reconfiguration of pipeline units is mainly categorized in two modes, shown in FIGS. 5A and 5B respectively. In other exemplary embodiment, a non-adaptive pipeline controller may be used.

FIG. 5A illustrates the pipeline controller in a first operation mode according to an exemplary embodiment. Referring to FIG. 5A, when a pipeline controller is configured with a certain number of cascaded arithmetic logic units (ALUs), a bi-directional data flow will be constructed. The bi-directional data flow is facilitated by a global or local clock, enabling the successive comparison of received analog signals to generate the digital code by which data in the selected storage units are refreshed. The storage units are selected based on the in-situ operation mode. Thus for the bit-wise control, the data will be written on the data bus Data1 in FIG. 4B, instead of overwriting the data written on the data bus Data0 during row- and column-wise control. The header and tail in FIG. 5A and FIG. 5B set the boundary for the said bi-directional data flow. A simplified design for the header or tail may be achieved by reusing an ALU while forcing the clocked data to reverse the propagation once it arrives.

FIG. 5B illustrates the pipeline controller in a second operation mode according to an exemplary embodiment. In the second mode, referring to FIG. 5B, for the remaining parts of the pipeline controller units, the data flow between any adjacent ALUs are cut off, and no further comparison of coupled analog signals will be performed. Thus, an unselected storage unit will remain with its original digital code.

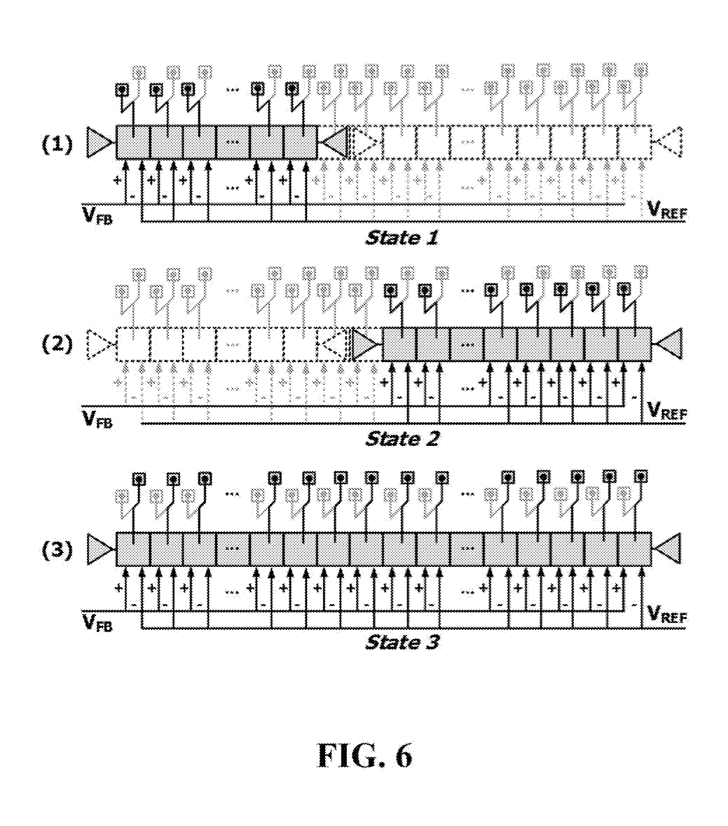

FIG. 6 shows the operation of an adaptive pipeline controller in three states according to an exemplary embodiment. As illustrated in FIG. 6, based on the two reconfiguration modes of FIGS. 5A-5B, an exemplary method of controlling the 3D power stage is used in implementation of the adaptive digital pipeline controller. To achieve better area efficiency, in some embodiments, a total number of 2×M_{B} storage units (e.g. latches) are used to account for access and control of M_{Total} power stage unit bits, assuming that M_{B} is at least one larger than the sum of M_{R} and M_{C}. This design criterion is determined to promote the use of as few storage units as possible since each storage unit consumes on-chip area. When using this criterion, M_{B} storage units are used to store M_{B}-bit long results from bit-wise control, and the other M_{B} storage units are divided into two parts: M_{R} storage units for rows and M_{C} storage units for columns. Using this type of division, M_{R}+M_{C}+M_{B} storage units are used to cover the data requirements for the entire M_{R}×M_{C}×M_{B} power stage units.

Referring to FIG. 6, the operation of the adaptive digital pipeline controller, which drives the equivalently large number M_{Total} of power stage unit bits, can be demonstrated in three steps. In order to regulate the output voltage V_{OUT} as in FIG. 2, the coarse digital code (e.g. equivalent to M_{R} rows and M_{C} columns) is first generated. The digital code is used for turning ON/OFF power stage units in a group of rows and a group of columns, represented by State 1 and State 2, respectively. After which, the fine digital bit code (e.g. equivalent to M_{B} bits inside the said active column) is further generated in State 3. The generation of the said row/column or bit code is from comparison of V_{REF} and V_{FB}. In other words, the in-situ regulation of output voltage is achieved by performing comparisons and turning bits ON/OFF in different combinations. Since the pipeline serves as a bidirectional data flow generator, the linear regulator determines whether to turn ON the next unit, or turn OFF a previously turned ON unit. The previously generated “0” or “1” needs to be stored along the pipeline, in order to make the determination. Therefore, not only does the pipeline in FIG. 6 State 3 require storage units, but the pipelines in State 1 and State 2 both require storage units. For example, the pipeline shown at State 1 of FIG. 6 provides row operation or row-wise control of M_{R} groupings, with each grouping having a size equal to M_{C}×M_{B} storage units. The pipeline shown as State 2 of FIG. 6 provides column operation or column-wise control of M_{C} groupings, with each grouping having a size equal to M_{B} units. The pipeline shown as State 3 of FIG. 6 provides bit operation or bit-wise control of M_{B} groupings, with each grouping having a size equal to 1 storage unit. This is why M_{R}+M_{C}+M_{B} storage units are used to cover effectively a M_{R}×M_{C}×M_{B} storage requirement.

It should be noted that, after being reconfigured based on the current state, the pipeline shall start the data flow in a similar way. Generally, for a more feasible implementation of reusable pipeline structures, the said data flow under each state distinguishes themselves mainly by two factors: first, the length of connected, or active pipeline ALUs; and second, which storage units will be used for storing the data used to control the power stage units. In some embodiments, as shown in FIG. 6, the pipeline for State 1 (row) and State 2 (column) may be reused, and the pipeline unit (ALU) may be reused as a header/tail to realize a bi-directional data flow, as explained in FIGS. 5A-B. In some cases, for ease of implementation, at least 1 unit gap may be left between the row-pipeline and column-pipeline.

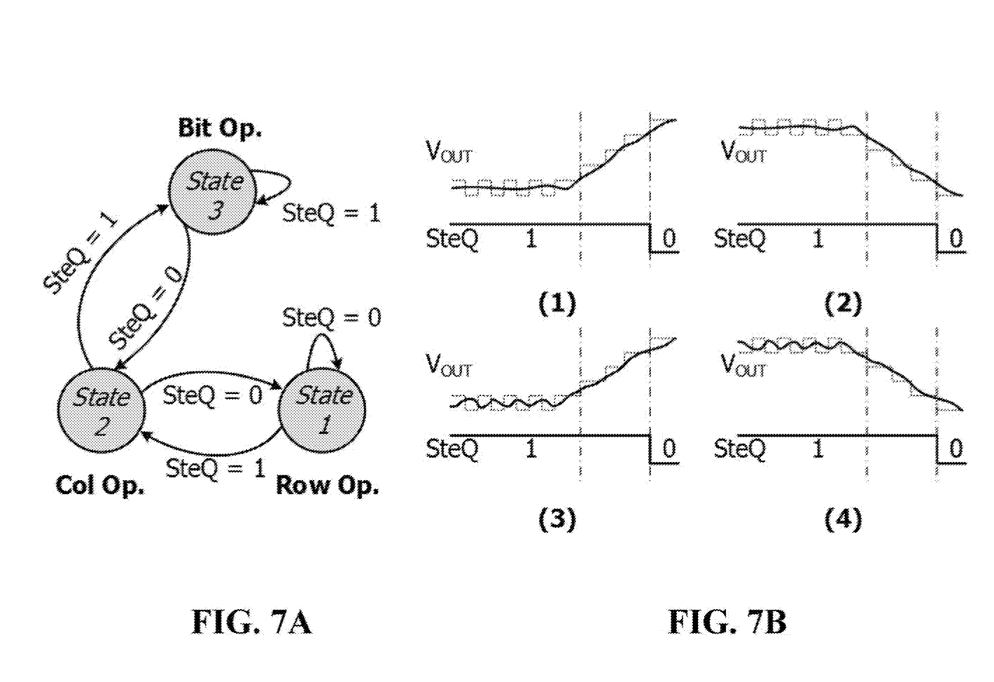

The digital pipeline controller, as shown in FIG. 6, is governed by a finite state machine (FSM). As illustrated in FIG. 7A, the FSM provides for appropriate reconfiguration of the pipeline structure, as shown in State 1, State 2, and State 3 of FIG. 6. Three pre-defined states “State 1”, “State 2” and “State 3” refer to access and control operation on row, column and bit, respectively.

The decision of the FSM's transition from a current state to a next state is dependent on how the digital code steady signal SteQ changes its value. FIG. 7B illustrates the generation of signal SteQ in four simplified general scenarios. For example, in graphs (1) or (2) of FIG. 7B, during a normal bit operation when the output voltage is finely regulated and no large variation of digital code is detected, SteQ remains “1” (true), and the digital controller, as in step (3) of FIG. 6, may continuously operate in bit-wise control. However, if for a time a certain number of digital codes are detected to have changed, SteQ is issued “0” (false), and the change of SteQ may drive the FSM to change its current state from “State 3” (bit-operation) to “State 2” (column-operation). It should be noted that the border of increasing or decreasing the number of turn-ON or turn-OFF bits varies for “State” 1 to 3, such that the signal SteQ still remains “1” in graphs (3) or (4) of FIG. 7B, as the ripple does not exceed the tolerance of one-bit change at column or row operation. Detection of change in SteQ signal may be achieved using digital logic.

As a result, the 3D power stage and the adaptive digital pipeline controller may both be coordinated by the FSM, which in combination may bring forth performance improvements in the application of the digital voltage regulator, especially enabling a balance in high speed response and high resolution of output voltage.

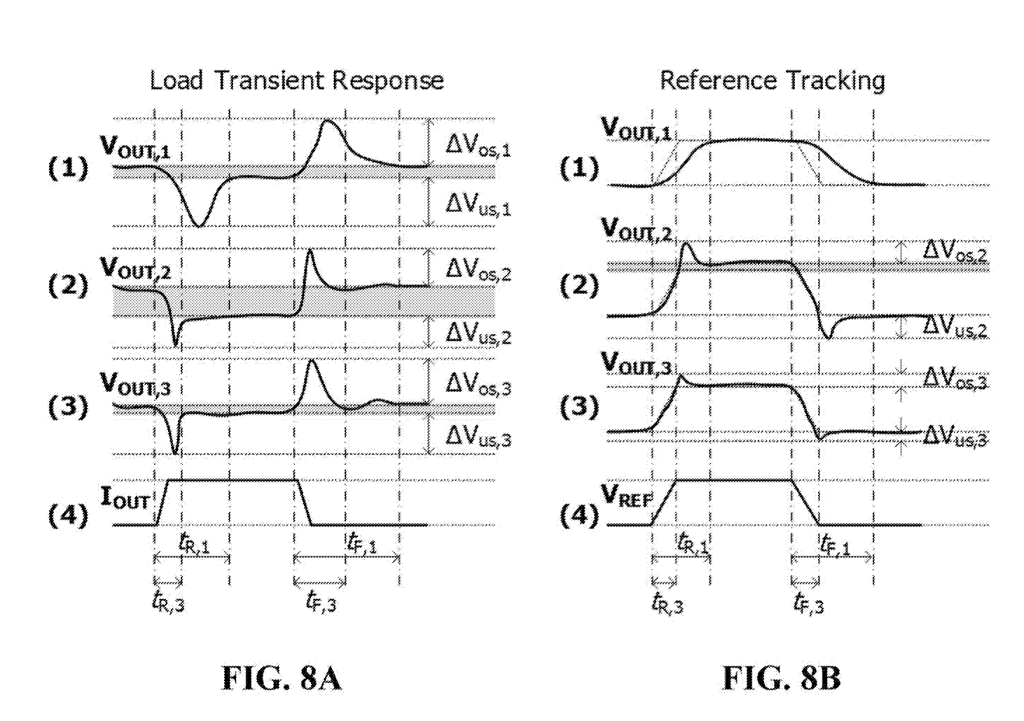

FIGS. 8A-8B illustrate comparisons for load transient response and reference tracking, respectively. In particular, a digital linear voltage regulator in an exemplary embodiment is compared with conventional digital linear voltage regulators which use a one-dimensional power stage.

Referring to the output voltage waveforms for the comparison of load transient response, illustrated in FIG. 8A, three output voltages are shown as graphs (1)˜(3) representing three digital linear regulators that are assumed to have the same maximum I_{OUT} capability. With the same total power stage sizing, graphs (1) and (2) represent the conventional digital linear regulator when the power stage is linearly divided into M₁ and M₂ units respectively, with the condition that M₁ is much larger than M₂. Graph (3) represents an output voltage V_{OUT} of a digital linear regulator that adopts adaptive techniques according to an embodiment of the invention, in which the power stage is divided into M₂ large units and each large unit is further divided into M₁ small units. Graph (4) represents a fast transient in the output current I_{OUT}, including a rising edge and falling edge.

From FIG. 8A, the output voltage V_{OUT,1}, as shown in waveform (1), has a fine resolution, implying a smaller variation for each bit change. However, the response speed is very slow because more bits need to be turned ON/OFF in a sequential order. In waveform (2), V_{OUT,2} achieves a fast speed response but is lacking resolution, which may cause incorrect digital operations. The undershoot and overshoot voltages of waveforms (1) and (2) are comparable due to the fact that the dynamic voltage shooting has a stronger dependence on current change range during load transient. The waveform (3), illustrating the output voltage V_{OUT,3} generated by an exemplary implementation of the invention, achieves improvements in performance—i.e., high response speed during load transient and high resolution to provide a well-regulated supply voltage.

Similarly, from FIG. 8B, the performance comparison of reference tracking is given by waveforms (1)˜(3) and the reference voltage V_{REF} waveform. As can be seen in FIG. 8B, the exemplary implementation of the invention (corresponding to waveform (3)), achieves improved reference voltage tracking speed and reduced overshoot and undershoot due to the adaptive resolution. Furthermore, the exemplary implementation of the invention is able to settle down to a fine regulated voltage, which is assured by the equivalent large number of bits that can be turned ON or OFF in voltage regulation in accordance with the 3D power stage and its adaptive pipeline control.

An exemplary voltage regulator built according to some embodiments of the invention in 65 nm low-leakage CMOS technology is able to operate between 0.6V and 1V and provide a maximum current of 500 mA to a capacitive load of 1.5 nF. The 65 nm regulator is shown to exhibit the best figures of merit compared to other regulators in literature.

An embodiment of the disclosure provides a technique for dividing and controlling power stage units for a speed-resolution balance. In this structure, power stage units are divided into a large number of small units such that the last bit error is significantly reduced for a fine resolution. The flexibility of simultaneously controlling one or more power stage units targeting an ultra-fast transient response is enabled by this technique.

Another embodiment of the disclosure provides a technique for controlling power stage units by reconfiguring a number of pipeline stages adaptive to in-situ transient speed or resolution requirements. A pipeline controller utilizing this technique may be reconfigured with different number of pipeline stages to digitally control a group of, or individual power stage units according to in-situ transient conditions. Additional criteria for the pipeline controller to realize area and power efficiency is also provided.

Yet another embodiment of the disclosure provides a digital linear voltage regulator including a power stage, arranged in a hierarchical grouping of power stage units. The power stage is configured to deliver power to a load. The digital linear voltage regulator further includes a mixed-signal controller, configured to control each power stage unit in the power stage by conditionally adjust a number of active power stage units in the power stage based on a comparison of a feedback voltage of the load and a reference voltage; wherein the hierarchical grouping of power stage units comprises N levels; wherein the power stage comprises a number of M_{N} Nth level units, and an Nth level unit comprising a number of M_{N-1} (N−1)th level units; and wherein N is an integer greater than or equal to 3, and M_{N} and M_{N-1} are integers greater than or equal to 1.

Embodiments of the disclosure further provide a digital linear voltage regulator, wherein the mixed-signal controller conditionally adjusts the number of active power stage units in the power stage by performing the steps of: (1) determining whether each row in the M_{R} rows should be activated or deactivated, and conditionally activating and deactivating each row accordingly, wherein all power stage units in an activated row deliver power to the load; (2) selecting a single row in the M_{R} rows and determining whether each column in the single row should be activated or deactivated, and conditionally activating and deactivating each column accordingly, wherein all power stage units in an activated column deliver power to the load; and (3) selecting a single column in the single row and determining whether each bit in the single column should be activated or deactivated, and conditionally activating and deactivating each bit accordingly, wherein all power stage units in an activated bit deliver power to the load; and wherein all power stage units in activated rows, activated columns, and activated bits are active power stage units.

Embodiments of the disclosure further provide an adaptive pipeline controller for a digital linear voltage regulator. The adaptive pipeline controller includes a plurality of ALUs with bi-directional data flow, configured to compare an input signal with a reference signal. The plurality of ALUs include M_{B} total ALUs with three configurations: (1) the plurality of ALUs are reconfigured into a subset of M_{R} ALUs in a first configuration with M_{R}≤M_{B}; (2) a subset of M_{C} ALUs in a second configuration with M_{C}≤M_{B}; and (3) all M_{B} ALUs in a third configuration. M_{R} is a total number of rows, M_{C} is a total number of columns, and M_{B} is a total number of bits. A row is made up of one or more columns, and a column is made up of one or more bits. The adaptive pipeline controller further includes M_{R}+M_{C} global latches, configured to store ALU results in the first configuration and the second configuration. The adaptive pipeline controller also includes M_{B} local latches, configured to store ALU results in the third configuration. A controller is included in the adaptive pipeline controller to combine the values of the M_{R}+M_{C} global latches with the M_{B} local latches to drive a power stage in the digital linear voltage regulator.

Embodiments of the disclosure further provide a controller that may be configured in three states: (1) a bit-wise state, where the M_{B} local latches are updated one at a time; (2) a column-wise state, where an equivalent total number of M_{B} latches are updated all at once when a latch in the M_{R}+M_{C} global latches is updated; and (3) a row-wise state, where an equivalent total number of M_{C}×M_{B} latches are updated all at once when a latch in the M_{R}+M_{C} global latches is updated.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A digital linear voltage regulator comprising:
a power stage, arranged in a hierarchical grouping of power stage units, the power stage configured to deliver power to a load; and
a mixed-signal controller, configured to:
control each power stage unit in the power stage, and
conditionally adjust a number of active power stage units in the power stage based on a comparison of a feedback voltage of the load and a reference voltage;
wherein the hierarchical grouping of power stage units comprises N levels;
wherein the power stage comprises a number M_{N} of Nth level units, and an Nth level unit comprising a number M_{N} of (N−1)th level units; and
wherein N is an integer greater than or equal to 3, and M_{N} and M_{N-1} are integers greater than or equal to 1.

2. The voltage regulator according to claim 1, wherein N=3 and the levels of the hierarchical grouping of power stage units are a first level or “row”, a second level or “column”, and a third level or “bit”;
wherein the power stage comprises M_{R} rows, a row comprising M_{C} columns, and a column comprising M_{B} bits; and
wherein M_{R}, M_{C}, and M_{B} are all integers greater than or equal to 1.

3. The voltage regulator according to claim 2, wherein a bit corresponds to one power stage unit.

4. The voltage regulator according to claim 2, wherein conditionally adjusting the number of active power stage units further comprises:
determining whether each row in the M_{R} rows should be activated or deactivated, and conditionally activating and deactivating each row accordingly, wherein all power stage units in an activated row deliver power to the load;
selecting a single row in the M_{R} rows and determining whether each column in the single row should be activated or deactivated, and conditionally activating and deactivating each column accordingly, wherein all power stage units in an activated column deliver power to the load; and
selecting a single column in the single row and determining whether each bit in the single column should be activated or deactivated, and conditionally activating and deactivating each bit accordingly, wherein all power stage units in an activated bit deliver power to the load;
wherein all power stage units in activated rows, activated columns, and activated bits are active power stage units.

5. The voltage regulator according to claim 4, wherein the mixed signal controller comprises a pipeline controller, wherein the pipeline controller is configured to use bi-directional data flow to activate and deactivate adjacent rows in the M_{R} rows, adjacent columns in the single row, and adjacent bits in the single column.

6. The voltage regulator according to claim 5, wherein the pipeline controller comprises M_{R}+M_{C}+M_{B} arithmetic logic units (ALUs); and
wherein M_{R} ALUs are configured to activate or deactivate power stage units in M_{R} rows, M_{C} ALUs are configured to activate or deactivate power stage units in M_{C} columns, and M_{B} ALUs are configured to activate or deactivate power stage units in M_{B} bits.

7. The voltage regulator according to claim 6, wherein the mixed signal controller further comprises M_{R}×M_{C} global latches and M_{B} local latches, wherein the M_{R}×M_{C} global latches store activated and deactivated status for all power stage units based on ALU results from the M_{R} ALUs and the M_{C} ALUs, and wherein the M_{B} local latches store status determined from ALU results from the M_{B} ALUs.

8. The voltage regulator according to claim 5, wherein the pipeline controller is an adaptive pipeline controller comprising M_{B} arithmetic logic units (ALUs), where M_{R}+M_{C}≤M_{B}; and
wherein in one reconfiguration of the adaptive pipeline controller, M_{R} ALUs of the M_{B} ALUs are configured to activate or deactivate power stage units in M_{R} rows, and in another reconfiguration, M_{C} ALUs of the M_{B} ALUs are configured to activate or deactivate power stage units in M_{C} columns, and in another reconfiguration, the M_{B} ALUs are configured to activate or deactivate power stage units in M_{B} bits.

9. The voltage regulator according to claim 8, wherein the adaptive pipeline controller further comprises M_{R}+M_{C} global latches and M_{B} local latches, wherein the M_{R}+M_{C} global latches store activated and deactivated status results from the M_{B} ALUs when reconfigured as M_{R} ALUs or M_{C} ALUs, and wherein the M_{B} local latches store status from the M_{B} ALUs otherwise.

10. The voltage regulator according to claim 2, wherein each power stage unit is a pass transistor.

11. The voltage regulator according to claim 2, wherein the load is selected from the group consisting of a static load and a switching load.

12. The voltage regulator according to claim 2, wherein the power stage is configured to provide a static voltage or a switching voltage.

13. An adaptive pipeline controller for a digital linear voltage regulator, comprising:
a plurality of arithmetic logic units (ALUs) with bi-directional data flow, configured to compare an input signal with a reference signal, the plurality of ALUs comprising M_{B} ALUs with three configurations, wherein the plurality of ALUs are reconfigured into a subset of M_{R} ALUs in a first configuration with M_{R}≤M_{B}, a subset of M_{C} ALUs in a second configuration with M_{C}≤M_{B}, and all M_{B} ALUs in a third configuration, wherein M_{R} is a total number of rows, M_{C} is a total number of columns, and M_{B} is a total number of bits, and wherein a row comprises one or more columns, and a column comprises one or more bits;
M_{R}+M_{C} global latches, configured to store ALU results in the first configuration and the second configuration;
M_{B} local latches, configured to store ALU results in the third configuration; and
a controller configured to combine the values of the M_{R}+M_{C} global latches with the M_{B} local latches to drive a power stage in the digital linear voltage regulator.

14. The adaptive pipeline controller of claim 13, wherein the controller is further configured to operate in three states:
a bit-wise state, where the M_{B} local latches are updated one at a time;
a column-wise state, where an equivalent total number of M_{B} latches are updated all at once when a latch in the M_{R}+M_{C} global latches is updated; and
a row-wise state, where an equivalent total number of M_{C}×M_{B} latches are updated all at once when a latch in the M_{R}+M_{C} global latches is updated.

15. The adaptive pipeline controller of claim 14, wherein the controller is further configured to use bi-directional data flow to determine the values to be stored in adjacent groupings of M_{R}+M_{C} global latches, and adjacent groupings of M_{B} local latches.

16. The adaptive pipeline controller of claim 13, wherein M_{R}+M_{C}≤M_{B}.

17. A digital linear voltage regulator, comprising:
a power stage, arranged in a hierarchical grouping of power stage units, the power stage configured to deliver power to a load; and
a mixed-signal controller, configured to conditionally adjust a number of active power stage units in the power stage based on a comparison of a feedback voltage of the load and a reference voltage;
wherein the hierarchical grouping of power stage units comprises N levels;
wherein the power stage comprises a number M_{N} of Nth level units, an Nth level unit comprising a number M_{N-1} of (N−1)th level units; and
wherein N is an integer greater than or equal to 3, and M_{N} and M_{N-1} are integers greater than or equal to 1.

18. The voltage regulator according to claim 17, wherein N=3 and the levels of the hierarchical grouping of power stage units are a first level or “row”, a second level or “column”, and a third level or “bit”;
wherein the power stage comprises M_{R} rows, a row comprising M_{C} columns, and a column comprising M_{B} bits; and
wherein M_{R}, M_{C}, and M_{B} are all integers greater than or equal to 1.

19. The voltage regulator according to claim 18, wherein a bit corresponds to one power stage unit.

20. The voltage regulator according to claim 17, wherein each power stage unit is a pass transistor.
